(19) United States
(12) Patent Application Publication
(10) Pub. No.: US 2015/0020003 A1
(43) Pub. Date: Jan. 15, 2015

(54) Interactions Between Users in a Virtual Space

(71) Applicant: Joseph F. Karam, Mountain View, CA (US)

(72) Inventor: Joseph F. Karam, Mountain View, CA (US)

(73) Assignee: GOOGLE INC., Mountain View, CA (US)

(21) Appl. No.: 12/054,045

(22) Filed: Mar. 24, 2008

(51) Int. Cl. G06F 3/00

(52) U.S. Cl. 715/756; 715/753

(57) ABSTRACT

Methods and apparatus, including computer program products, implementing and using techniques for establishing interaction between users simultaneously viewing a virtual representation of a physical object on computers connected to a network. A view of a portion of the physical object is displayed to a user. The view is based on a set of coordinates that identifies a current position of the user. One or more figurines representing other users are displayed within the view. The other users are simultaneously looking at a similar portion of the physical object. Each figurine is shown at a coordinate position corresponding to a current position of a respective other user. A request user to interact with one or more of the other users is received from the user. The request is transmitted to the other users. Based on responses received to the request, interactions between the requesting user and the other users are established.

### BACKGROUND

This invention relates to computer software enabling interactions between users in a shared virtual space. One of the many uses of computer networks, such as the Internet, is to enable people to make new acquaintances “online.” There are a variety of different forums that are used for this purpose, such as chat rooms, message boards, or shared three-dimensional virtual spaces. The designers of such online or virtual environments often go to great lengths to simulate environments that are as close to real life environments as possible. One aspect that is among the most difficult ones to simulate in an online environment is a sense of a common purpose, both in the immediate sense in and in the larger sense, coupled with an atmosphere of serendipity, synchrony and fun.

One type of online environment which many users find fascinating and intriguing is known as Google Earth and provided by Google Inc. of Mountain View, Calif. Several versions of Google Earth exist, but the main purpose and functionality is the same in all versions. On a conceptual level, Google Earth can be described as a virtual globe that sits inside a user's personal computer. A user can point and zoom to any place on Earth that she would like to explore. When doing so, satellite images and local facts zoom into view on the user's display screen. Users can also look up specific addresses, get driving directions, and “fly” along a route. Generally speaking, all of these tasks are achieved by running client applications on the user's computer, which communicates with a remote server over a network, such as the Internet. The client applications send data to the remote server about the user's position in space (for example, in the form of an (x,y,z) coordinate triplet). In response to receiving this information, the remote server presents the user with satellite images that are displayed to the user by the client application in such a manner that they appear to the user as if the point of view were the user's coordinate position. Doing this dynamically in real-time gives the user the sensation of “flying” above the surface of the Earth.

While most users find it fascinating to explore different parts of planet Earth, it can be a solitary type of activity.

### SUMMARY

In general, in one aspect, the invention provides methods and apparatus, including computer program products, implementing and using techniques for establishing interaction between two or more users simultaneously viewing a virtual representation of a physical object on two or more computers connected to a network. A view of a portion of the physical object is displayed to a user. The view is based on a set of coordinates that identifies a current position of the user. One or more figurines are displayed in the view. The figurines represent other users that are simultaneously looking at a similar portion of the virtual representation of the physical object. Each figurine is shown in the current view at a coordinate position corresponding to a current position of a respective other user. A request is received from the user to interact with one or more of the other users whose figurines are displayed within the current view. The request is transmitted to the one or more other users. Interactions between the requesting user and the one or more other users are established based on responses received from the one or more other users to the request.

Advantageous implementations can include one or more of the following features. Displaying figurines can include displaying figurines only of other users that would like to be visible to the user. Displaying figurines can include displaying customized figurines of at least some other users, according to preferences selected by the other users represented by the customized figurines. The customized figurines can include one or more of: a geometrical shape, a color, an image, and a video. The customized figurines can include a status indicator showing the other users' availability for interactions with the user.

Receiving a request from the user to interact with one or more of the other users can include receiving a request to broadcast a message to all other users whose current position is within a region of influence centered on the current position of the user. The region of influence can be a sphere of a specified radius, centered on the current position of the user. Receiving a request to broadcast a message to all users within a region of influence can further include determining whether the user has permission to broadcast a message to all other users within the region of influence, and broadcasting the message if the user has permission.

Receiving a request from the user to interact with one or more of the other users can include receiving a request to send a private message to a single user. Receiving a request from the user to interact with one or more of the other users can include receiving a request to broadcast a message to a selected group of other users independently of the current positions of the other users in the selected group of other users. The interactions between the requesting user and the one or more other users can include one or more of communicating by instant text messages, communicating by audio, and communicating by video. Receiving a request from the user to interact with one or more of the other users can include receiving a request to join one of the other users at the other user's current position and to look at a same portion of the virtual representation of the physical object. The other user can be joined when the other user moves from the current position of the other user to a different position.

A request can be received from the user to add a place mark to the current position before moving to a new position. The place mark is visible to the other users and provides a means for the other users to request interaction with the user after the user has moved away from the current position. A user can move from the current position to a new position and leave a trail visible to the other users, such that anyone of the other users can follow the path taken by the user when moving from the current position to the new position. Contact information can be saved in a list about the one or more other users with whom interactions were established, such that the one or more other users can be contacted again. The one or more other users can be asked for permission to save their contact information in the list, and contact information can be saved only for the one or more other users who give permission to save their contact information. The virtual representation of the physical object can be a virtual representation of planet Earth that is generated from satellite imagery of planet Earth, and the portion of the physical object can be a geographical region of planet Earth.

In general, in another aspect, the invention provides methods and apparatus, including computer program products, implementing and using techniques for interacting with one or more users in a shared virtual reality space representing planet Earth. The shared virtual reality space is generated from satellite imagery of planet Earth. A set of coordinates is sent to a remote server. The set of coordinates represents a current position of a user in the shared virtual reality space. Information representing a view of a geographical portion of planet Earth from the current position of the user is received from the remote server. A set of figurines is received from the remote server. The figurines represent one or more other users that are simultaneously located proximate to the current position of the user in the shared virtual reality space. The received information and set of figurines is displayed to a user and each figurine is shown at a position corresponding to each other user's current position. A user input requesting an interaction with one or more of the other users is received. The request is transmitted to the remote server and interactions are established between the requesting user and the one or more other users based on response information to the request received from the server.

The invention can be implemented to include one or more of the following advantages. Users can toggle in and out of a mode where they become visible to and can be contacted by other users. Users can personalize their flying figurines and duplicate their presence by placing sentinels. Users can engage each other synchronously through textual, audio and video communication. Users can employ these types of media to communicate through public broadcasts to several other users, and/or to select users through private communication channels. Users can co-browse planet Earth by merging points of view and sharing navigation controls determining what portions of planet Earth to look at. Users can ask other users for permission to access their current location, in order to more easily find them again at a later point in time. Users can indicate their availability status for interactions with other users, such as “I'm just here to observe,” “Please feel free to engage me in conversation,” or “Please do not disturb,” and so on.

These tools and features enable a variety of scenarios and use cases. For example, the tools allow users to meet by chance and connect with new people who may have similar geographical interests, since the users are exploring similar portions of planet Earth. By interacting with other users, it is also possible to find and discuss information that is not accessible through regular use of Google Earth, since other users may provide further information and contribute their own personal knowledge about specific geographic regions. Users can lead one or more users through real-time guided tours while answering their questions. Virtual gatherings can be staged, for example, friends can decide to gather in one place, or public demonstrations can be staged for the world to see.

In a larger sense, Google Earth provides a shared virtual space that has the potential of creating a sense of common purpose, coupled with an atmosphere of serendipity, synchrony and fun in a way that has not been possible before. For example:
Immediate Shared Purpose: If two people are looking at the same part of planet Earth, especially when observing the surface at closer zoom levels, they likely have a common intention, they might have unanswered questions, or they might simply want to share reactions with other users.
Lasting Shared Purpose: Planet Earth is an inspiring symbol, because it reminds humans of the level of kinship that is common to all of them. When two users first communicate while jointly flying over a three-dimensional representation of planet Earth in the background, it can be a powerful association.
Serendipity: Allowing people to navigate freely in a three-dimensional environment and bump into each other creates small windows of opportunity while offering users spatial control over their virtual paths. Furthermore, exploring Google Earth is an activity in its own right, and as such, it offers a context where communicating with other users is optional to the original pretext of exploration.
Synchrony: Making contact with a passing traveler is best achieved through the uses of instantaneous textual, audio and/or video communication tools. Additionally, allowing users to merge their points of view into a co-browsing mode contributes to real-time sharing and exploring.
Fun: Users typically use Google Earth as an exploratory, spatial tool to travel virtually, primarily for fun, as opposed to other more goal-oriented tools that are used to search for specific information.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 is a schematic view showing a shared three-dimensional virtual space in which Users A-E are distributed in accordance with one embodiment of the invention.

FIG. 2 is a schematic view showing how Users A-E communicate with each other and a remote server over a network in accordance with one embodiment of the invention.

FIG. 3 is a screenshot showing how multiple users can interact within the shared three-dimensional virtual space in accordance with one embodiment of the invention.

FIGS. 4A-4C show some examples of virtual figurines and status indicators that can be used to represent users in accordance with various embodiments of the invention.

FIG. 5 is a screenshot similar to FIG. 3, but including skywriting and place mark features in accordance with various embodiments of the invention.

FIG. 6 is a schematic example of a communication panel allowing selection of recipients of messages in accordance with one embodiment of the invention.

FIG. 7 is a screenshot similar to FIG. 3, showing a broadcast invitation to join another user, in accordance with one embodiment of the invention.

FIG. 8 is a screenshot similar to FIG. 7, showing a user responding to the invitation, in accordance with one embodiment of the invention.

FIGS. 9A-9B is a screenshot showing how a user joins another user and how they share a common view, in accordance with one embodiment of the invention.

FIG. 10 is a screenshot showing how a group of users can gather as a group, in accordance with one embodiment of the invention.

FIG. 11 is a screenshot of a zoomed-out version of the screenshot in FIG. 10 showing how the users can gather in a predetermined formation to send a message, in accordance with one embodiment of the invention.

Like reference symbols in the various drawings indicate like elements.

### DETAILED DESCRIPTION

As was described above, on a conceptual level, Google Earth can be described as a virtual globe that sits inside a user's personal computer. A user can point and zoom to any place on Earth that she would like to explore. When doing so, satellite images and local facts zoom into view on the user's display screen. Users can also look up specific addresses, get driving directions, and “fly” along a route. Various embodiments of this invention allow users to become represented in the three-dimensional virtual Google Earth space and to become visible to others as a figurine spatially located at the coordinate position of their point of view. Whenever the person represented by the figurine changes points of view (i.e., positions) using the keyboard or mouse controls (or other input device) on his computer, the figurine moves accordingly in space. Expressed differently, the point of view of a user and the point in space where that same user appears to other users are one and the same.

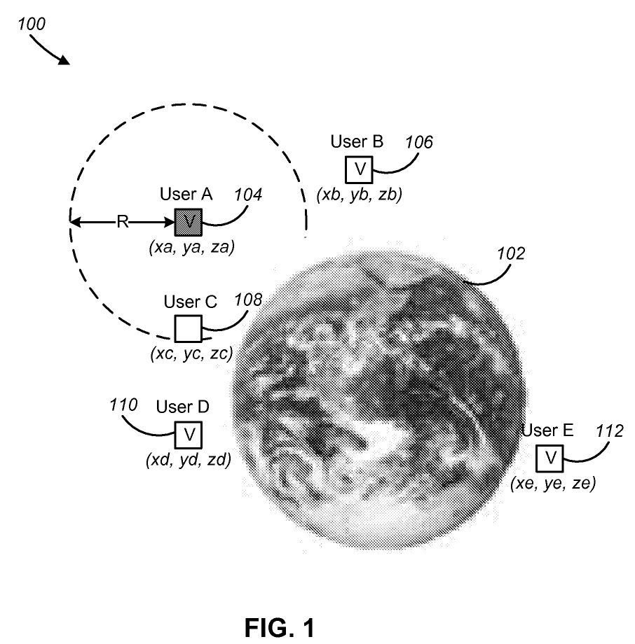

FIG. 1 shows a schematic view of a shared three-dimensional virtual space (100) of planet Earth, in which Users A-E are distributed in accordance with one embodiment of the invention. As can be seen in FIG. 1, each user has a location around planet Earth (102) that is determined by a coordinate triplet. For example, User A (104) is located at the coordinate position (xa, ya, za), User B (106) is located at the coordinate position (xb, yb, zb), User C (108) is located at the coordinate position (xc, yc, zc), User D (110) is located at the coordinate position (xd, yd, zd) and User E (112) is located at the coordinate position (xe, ye, ze). Each user views the Earth (102) and their surroundings on their respective display screens as if the user were physically located at their current coordinate position. For example, User A (104) is located at a position where she can see User B (106), User C (108) and User D (110), but not User E (112), who is located on the opposite side of the globe.

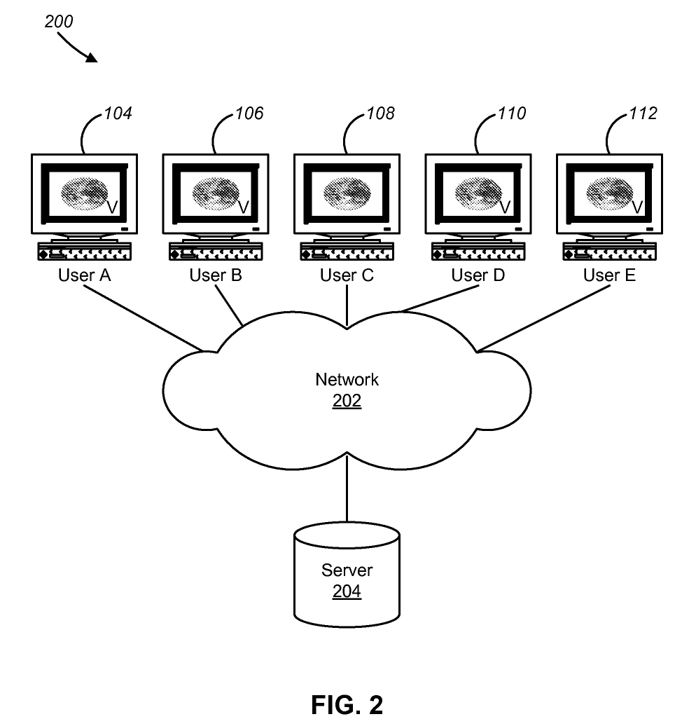

In some embodiments, which will be described in further detail below, in order to be visible to other users and to be able to see other users, a user must switch on a visibility toggle. This is indicated by a “V” for each user shown in FIG. 1. As can be seen in FIG. 1, in these embodiments, User A (104) would still be able to see User B (106) and User D (110), but not User C (108), who has not turned on his visibility toggle. Conversely, User C (108) would not be aware that there are any other users around her, since her visibility toggle is switched off. In other embodiments, a user will be visible to all users that have turned on their visibility toggles, even if the user has not turned on her own visibility toggle. In this case, the user will show up as an anonymous figurine on the other users' display screens. The mechanisms behind the visibility toggle and how users can view other users will now be explained with reference to FIG. 2.

As was described above, and can be seen in FIG. 2, each user (104, 106, 108, 110, 112) has a client application running on the user's computer. The client applications communicate with a remote server (204) over a network (202), such as the Internet. The client applications send the users' coordinate data to the remote server (204). In response to receiving this information, the remote server (204) presents the respective users with stored satellite images over the network (202). When the images are received, the client applications display the images to the users in such a manner that the images appear to the user as if the user's coordinate position is the point of view.

As can be seen in FIG. 2, User A (104), User B (106), User D (110) and User E (112) have all turned on their visibility toggles (indicated by a “V” on the respective user displays) in their client applications, for example, by clicking a checkbox on a graphical user interface (GUI). As a result, the remote server (204) checks whenever a user's coordinate position is received, whether there are any other users that have coordinate positions within the field of view of the user. If there are other users with in the user's field of view, then the remote server (204) displays a floating three-dimensional object, herein referred to as a figurine, for each other user at each other user's current position within the field of view. When a user changes positions, the other users will see the figurine move. When the user changes the orientation of his gaze, the other users will see the figurine rotate. When the user gets closer to other users, the other users will see the figurine bigger and clearer, and will also perceive the user's comments more distinctively, as will be discussed in further detail below.

In one implementation, the flying figurines occupy a specific volume of the virtual space that remains to scale relative to the representation of the Earth (e.g. a cube of dimensions 20 m×20 m×20 m). As a figurine representing a user gets further away from the viewpoint of another user, the figurine's two-dimensional representation will shrink, similar to what it would appear in real life. When the figurine is far away enough that the representation of the figurine reaches a certain arbitrary threshold of smallness, (e.g. a couple pixels), the figurine never quite disappears, but is instead replaced by a tiny dot-like icon, which would require minimal computing power to continue to display. As will be discussed below, in one implementation, similar principles apply for sound, where past a certain point, the sound might be turned off and instead be replaced by a visual indicator. As the skilled person realizes, most figurines will be invisible anyway when a user is zoomed in close to the surface of planet Earth. In situations when a user is not zoomed in close to the surface of planet Earth, the figurines representing other users will typically be at a far distance, and thus have a small enough dot-like representation as to not obscure the view of the user.

In some embodiments of the invention, all the other users' orientations are in the direction of the gaze of the user looking at his display screen. That is, returning to FIG. 1, User A (104) will appear to User B (106) as if User A (104) was looking directly at User B (106). At the same time, however, User A (104) appears to User D (110) as if User A (104) was looking directly at User D (110). This is despite the fact that User B (106) and User D (110) are actually looking at User A (104) simultaneously from two essentially orthogonal directions.

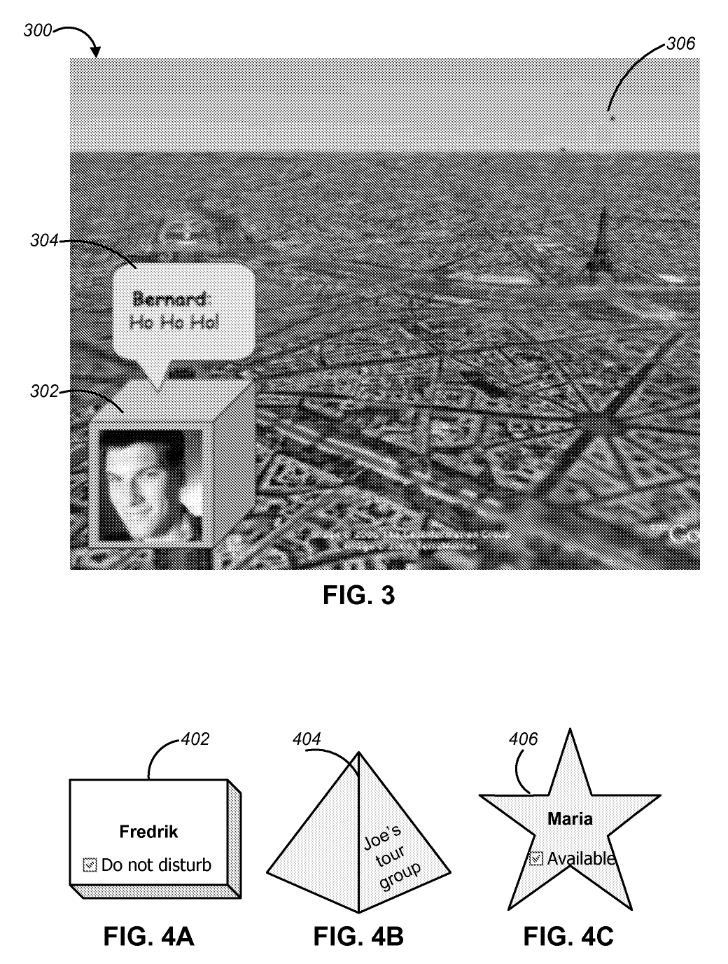

FIG. 3 is a screenshot (300) of a user's display screen, showing how multiple users can interact within the shared three-dimensional virtual space in accordance with one embodiment of the invention. As can be seen in FIG. 3, the user is flying above Earth, in this case over Paris, France. Another user, Bernard, represented by a floating figurine (302), appears in the lower left corner of the display screen. As the holiday season is coming near, Bernard jokingly broadcasts a message “Ho Ho Ho!” (304) to any other users in his vicinity, as he zooms off towards the Eiffel Tower. Since the user is located at a position relatively close to Bernard's figurine (302), he can clearly perceive Bernard's comment (304), as seen in FIG. 3. As Bernard's figurine (302) later disappears in the distance, the figurine (302) and the text bubble (304) become smaller, and the user can no longer perceive Bernard's comments as clearly. If Bernard had chosen to communicate over audio rather than through a text medium, the strength of his audio signal would become lower as Bernard disappears in the distance. The various communication modes that can be realized in accordance with various embodiments of the invention will be discussed in further detail below. It should be noted that another user (306) can also be seen in FIG. 3, but since this other user is far away from the current user's position, the other user's figurine (306) is only visible as a small dot in the distance and no comments from this user can be perceived.

In some embodiments, the users can personalize their flying figurines using their client applications. Some examples of personalized figurines can be seen in FIGS. 4A-4C. The users can choose from a number of geometrical shapes, such as a rectangle or square (402), a pyramid (404), a sphere, a cylinder, and other similar types of geometrical shapes. In some embodiments, the users can also upload their own figurines, such as the star (406) shown in FIG. 4C. In one implementation, when users upload their own figurines, the figurines have to meet certain size requirements and remain below certain complexity thresholds. Figurines can also be animated, provided that the figurines meet the size and complexity requirements. For example, a user's figurine may have two wings that flap as the figurine flies away in the distance.

In some embodiments, the users can select the color of their figurine from a set of recommended colors that will stand out well against the satellite imagery background. In other embodiments, the users can choose their own colors. Colors can also be used to indicate an “availability status” for the user on the figurine to mimic the visual cues that are perceived in the real world by observing other people's body language. For example, red can indicate “Do not disturb,” yellow can indicate “I'm just here to observe,” and green can indicate “I'm available to be engaged in conversations or other interactions.” In some embodiments, these “availability status” indicators can be represented as text, such as the “Do not disturb” message in FIG. 4A, and the “Available” message in FIG. 4C, respectively. Any combination of color or text is also possible.

In some embodiments, the users can customize their figurines with a text message, such as “Fredrik,” “Joe's tour group,” and “Maria” in FIGS. 4A-4C, respectively. In some embodiments, the users can choose to display a static picture of themselves on the surface of their figurine (see, for example, Bernard's figurine (302) in FIG. 3), so that other users can see what the user looks like in real life. In some embodiments, the static picture can be replaced by streaming video if the user has a web camera, so that the other users can see what the user looks like right now and experience that genuine live twinkle in the user's eye. In some embodiments the figurines can contain links that when clicked links to a user profile stored on the server (204) for the user represented by the figurine, so that other users can obtain more information about the user before contacting or otherwise interacting with the user.

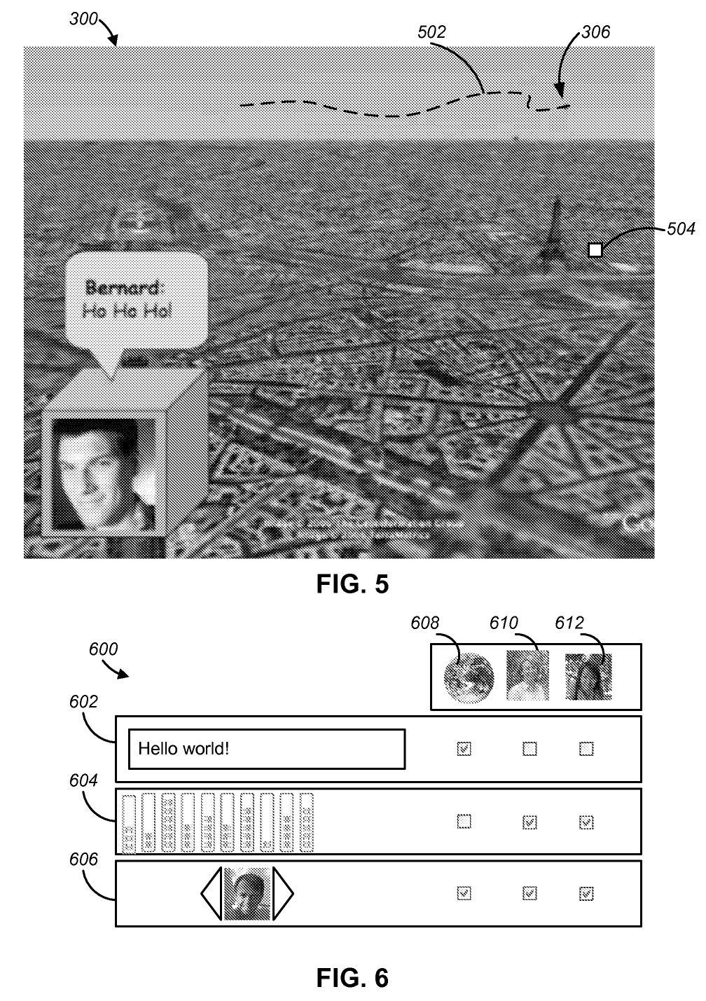

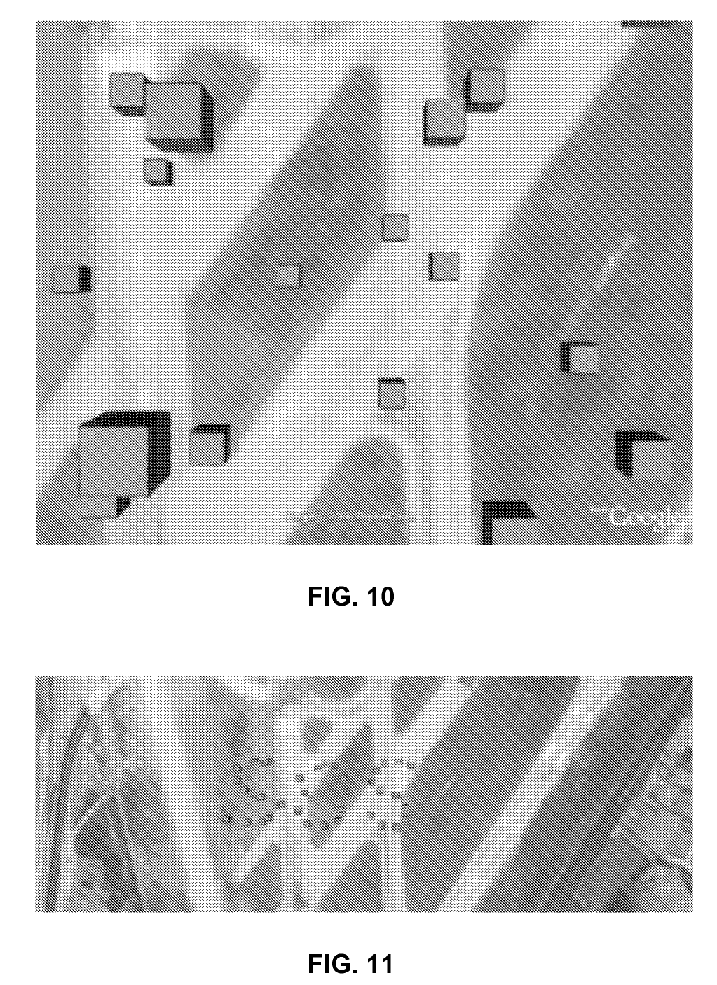

In some embodiments, such as the one shown in FIG. 5, a user (306) can select to leave a trail (502) behind their path to increase visibility and allow other users to find him more easily. This can be done, for example, by the server (204) keeping track of the user's most recent positions and supplying them to the other users' client applications along with the user's current position. Alternatively, the trail (506) can be used by the leader of a group of users, such that the other users in the group that are “flying” manually behind the leader can more easily follow the leader's path. Groups and formation flying will be discussed in further detail below with reference to FIGS. 10 and 11.

Another feature that is used in some embodiments to facilitate finding other users is to place sentinels (504) at specific coordinate positions on the representation of Earth. A sentinel (504) can be represented as a semi-transparent “ghost image” of the user's figurine. In some embodiments, this is accomplished by the server (204) keeping records of a specific set of positions, at the user's request, and supplying those positions to other users in the vicinity. When another user selects the sentinel (504), the user who placed the sentinel will be contacted, regardless of his current position. In some embodiments, selecting a sentinel (504) also allows the other user to move from the sentinel's position to the current position of the user represented by the sentinel (504).

As was noted above, in the various embodiments of the invention the users can communicate with each other using one or more of three channels: text, audio, and video. These channels are not mutually exclusive and can be used concurrently. As has also been noted above, each of these channels can be used either publicly (also referred to herein as “broadcasting”) or privately (also referred to herein as “whispering”).

In some embodiments, when a user publicly broadcasts a text message, the text message propagates spherically around the user and reaches all users whose position falls within a particular radius that the user has chosen. This is schematically illustrated in FIG. 1, where User A (104) has chosen a broadcast radius R. As can be seen in FIG. 1, User A's message only reaches User C (108), whose current position is within the broadcast radius R. All other users are too far away to notice User A's message. As can be seen in FIGS. 3 and 5, in some embodiments, a text broadcast has the format of text in a bubble (304) pointing towards the user and including the user's name. If the user is at a position that is outside another user's display screen, but still within the broadcast radius, a bubble (304) will still show up on the other user's display screen, but point towards the edge of the display screen that is closest to the user broadcasting the text message. The further away the user is from the other users, the smaller the bubble (304) and font in the bubble will be, which may entice at least some of the other users to come closer in order to be able to read what the user is broadcasting.

Broadcasting, as described here, can be implemented by the broadcasting user's client application sending to the server (204) the broadcasting user's text message together with his current position. The server (204) then identifies what other users are in the vicinity of the broadcasting user and transmits the message to these other users, together with the position coordinates of the broadcasting user. The receiving users' client applications then adjust the text font size according to the distance between the broadcasting user and the respective receiving users.

When a user privately whispers a text message to another user, the user's text will appear to the other user in large clear fonts, regardless of the distance separating the two users. In some embodiments, the private whisper will not appear in a bubble but instead in a distinct chat module not pointing at anyone. In some embodiments private whispers can be sent simultaneously to more than a single user. Regardless of whether the private whisper is sent to a single user or to a group of users, only the selected recipients will be able to see the text in the private whisper.

The whispering, as described here, can be implemented by the sender's client application sending to the server (204) the sender's text message together with his name and picture or video. The server (204) then transmits the message only to the other users that have been specified by the sender (i.e., here the location of the sender is insignificant). The receiving users' client applications then display the name and picture or video, and the message from the sender, for example, in the bottom left corner of the display screen. No adjustments are made of the text font size based on the distance between the sender and the recipients.

If a user decides to publicly broadcast an audio message, the audio message will propagate spherically around the user and reach all other users within the chosen broadcast radius, similar to the way text messages behave as described above. In some embodiments, the recipients of the audio message will hear the user's voice in stereo, from the direction the message is coming from in the three-dimensional space, whether the broadcasting user is in the line of sight of the receiving user or not. The further away the broadcasting user is from the receiving users, the fainter the volume of the broadcasting user's voice will be. Similar to the text messaging above, if the receiving users are intrigued, they will have to fly closer to the broadcasting user.

In some embodiments, when a user privately sends an audio message to another user, the user's voice will appear to the other user loud and clear, regardless of the distance separating the two users. The sound will not be directional, but will simply fill up the other user's auditory space. No one other than the receiving user will hear the sending user's voice, but as in text messaging there can be more than one receiving user.

In some embodiments, when a user publicly broadcasts a picture or a live streaming video of himself, the picture or video is visible on the user's figurine to any other users that are sufficiently close to see the figurine. The further away the user is from other users, the smaller the figurine will appear, and as a result, the smaller the picture or video will also appear. Similar to the text and audio messaging above, if the receiving users are intrigued, they will have to fly closer to the broadcasting user.

When a user privately sends a picture or live streaming video of himself to someone, the picture or video will appear large and crisp, regardless of the distance separating the two users. The picture or video will not appear on the user's figurine, but in a distinct image module. No one other than the receiving user will se the sending user's picture or video, although there can be several recipients, just as in the above text and audio communication scenarios.

The selection of an audience for broadcast or private transmissions of messages can be done in a variety of ways. In some embodiments of the invention a communication panel is used for this purpose. FIG. 6 shows such an exemplary communication panel (600). As can be seen in FIG. 6, the communication panel (600) allows the user to not only select recipients, but also to select what type of transmission (text, audio, video or any combination thereof) the different recipients will receive, by selecting different checkboxes. In the illustrated example, the user has decided that whatever is typed into a text box (602) will be publicly broadcast to the world (608), that is, the text will be broadcast spherically around the user and reach anyone who happens to be within the broadcast radius, as described above.

The user has also decided that whatever he says in his microphone, represented by an audio field (604), will always reach his contacts Stefanie (610) and Yan (612) directly, provided they are logged-on, but not any other people. That way, the user, Stefanie (610) and Yan (612) can be looking at different parts of the globe, yet still be communicating with each other.

As for his picture, shown in the video field (606), the user has employed the white arrows to browse through his album and settled on the one displaying his face, which he chose to display to everyone flying near his figurine, as indicated by the globe (608) and also set it so that Stefanie (610) and Yan (612) would always see it in a corner of their display screen whenever the user speaks up. If the user decides, he may at some later point replace this photo with a streaming video, as described above.

In some embodiments, there can be limitations of how many broadcast messages a user can send out to everyone around him. For example, the communication panel (600) can have an associated meter that contains a number of credits that are awarded to the user on a regular basis. Whenever a user broadcasts a public message a certain amount of these credits are used up. In some embodiments, more credits are used if the user selects a large broadcast radius compared to if the user selects a small broadcast radius. In some embodiments, more credits are used if there are many users around him, compared to if there are few users around him. This would, for example, limit the number of broadcasts over a densely populated or visited area, such as Paris, while allowing a user to broadcast to his hearts delight over a sparsely populated or visited area, such as the Kalahari Desert. In other embodiments, a user can only broadcast a message every few minutes or hours. Many variations of such broadcast meters will be apparent to those of ordinary skill in the art.

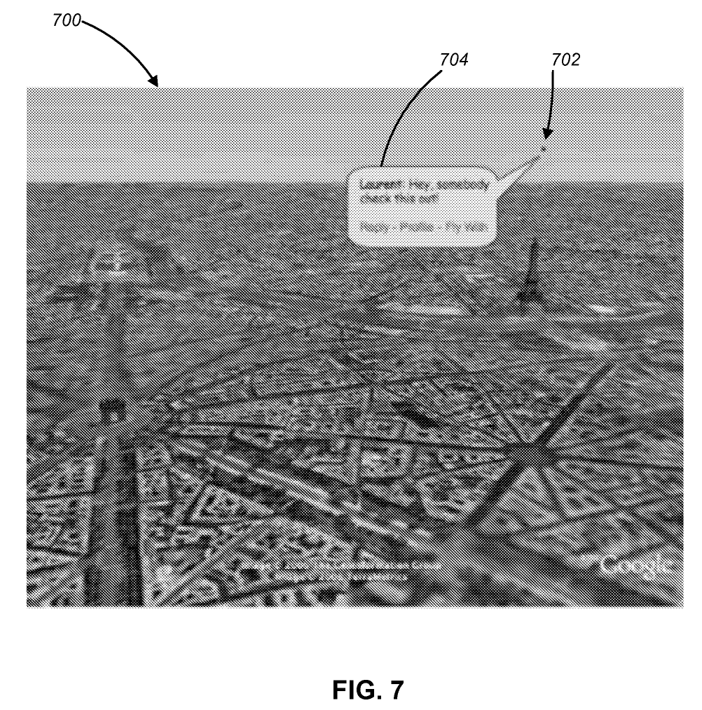

Some embodiments of the invention enable functionality referred to as “vision sharing.” Vision sharing allows users to co-browse the globe and fly with other users. FIGS. 7-9 schematically show how vision sharing works. FIG. 7 is a screenshot (700) similar to the one shown in FIG. 3 showing a broadcast invitation to join another user, in accordance with one embodiment of the invention. A user, Laurent (702), send out a broadcast message (704) “Hey, somebody check this out!” inviting other users to fly with him. The broadcast message contains three links that the other users can click on: a “Reply” link that can be used to send a reply to Laurent's broadcast message (704), a “Profile” link that can be used to obtain further information about Laurent stored on the server (204), and a “Fly with” link that can be used to join Laurent (702) at his current position.

It should be noted that the method of inviting other users to join you that is shown in FIG. 7 is merely one exemplary method. In some embodiments, a user can request to fly with another user, rather than being invited. The invitations and requests do not have to appear as public broadcasts, but can also be initiated by, for example, right-clicking on the other user's figurine or the other user's name if it is already stored as a place mark. A user can have multiple other users joining her as a group and can break up the group at any time. Conversely any user can break free from the group at any time.

In some embodiments, the user in control of the group can specify a particular flight formation that the following users must assume. These formations can be selected from a set of geometrical shapes, or, if the user has a sufficient number of followers, the user can choose to spell out letters to form words with his formation. This feature will be discussed in further detail below with reference to FIGS. 10 and 11.

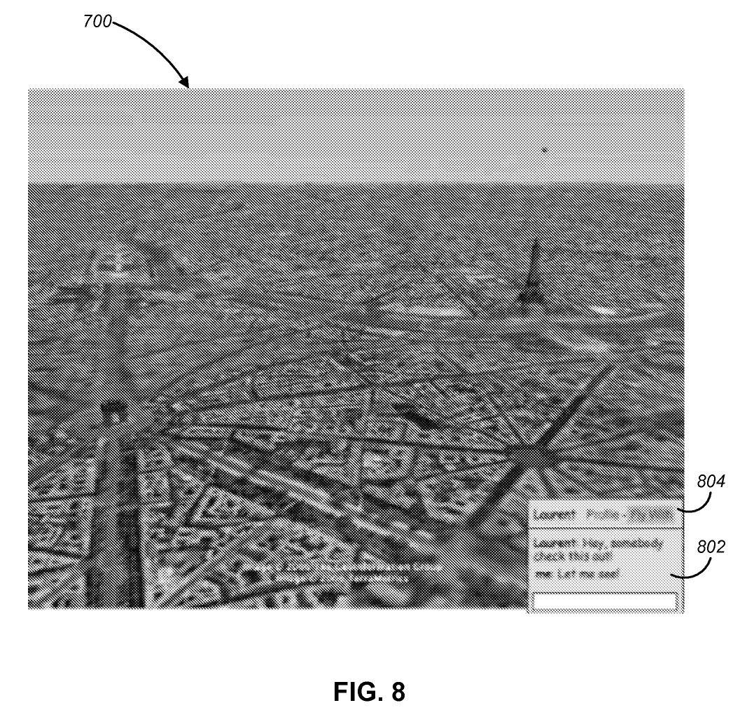

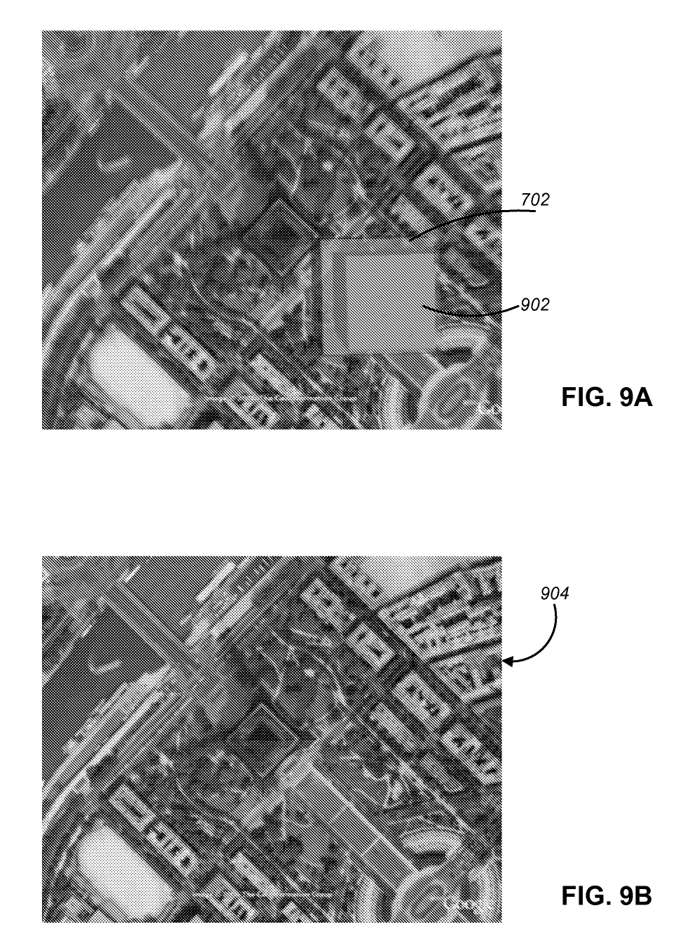

Returning now to FIG. 7, if the user decides to reply to Laurent's invitation (704), the user clicks the “Reply” link. This opens a dialog box (802), which is shown in FIG. 8. The user responds “Let me see” and clicks a “Fly with” link (804). When the “Fly with” link (804) is clicked and Laurent grants permission to the user to fly with him, the user's point of view changes and the user flies to Laurent's position, where the user's figurine (902) is merged with Laurent's figurine (702), as shown in FIG. 9A. This can be accomplished by copying Laurent's position data to the user. After merging, Laurent and the user share a common view, as shown in FIG. 9B, and Laurent is in charge of any subsequent movements and position changes until the user decides to break loose from Laurent and not fly with him any longer. Of course, Laurent and the user can still communicate while flying together, and the user can still broadcast public messages and send private messages, as described above.

At some point, Laurent may decide to hand over the controls to the user or any other guest that is concurrently flying with him. If the user accepts, the user will become the host and start controlling the course of the flight for everyone else onboard. In some embodiments it is also possible to yield control to someone other than the guests that are currently part of the formation. For example, if Laurent decides to join someone else's flight, Laurent and all his guests will be added to the list of guests of that new host. This can be, for example, a useful technique to quickly round up a group of friends.

In some embodiments, the host has a “passenger list” of the guests flying with the host. The guests can see the guest list, which has a special marker indicating who the host is. Whenever a host inputs changes in position through his client application, these position changes are transmitted to the server (204). The server (204) then transmits the same position updates and relevant imagery data to all the guests, including the host. The host can select any guest (or any guest can request control from the host), for example, by right-clicking on the guest's name and then selecting an option to pass control. The guest who has been asked to take control, or a host that has been asked to give control, can either accept or refuse the request. When control is successfully passed, the server (204) stops receiving input from the former host and begins parsing input coming from the newly appointed host, and then transmitting the same position updates and relevant imagery data to all guests, including the new host.

FIGS. 10 and 11 show how a group of users can gather in a particular formation, in accordance with one embodiment of the invention, and spell out messages to other users. FIG. 10 shows a zoomed-in screenshot of multiple users' figurines over a particular region of planet Earth. FIG. 11 shows a zoomed-out screenshot of the same group of users, where it can clearly be seen that the users' formation spells out the letters “SOS.” Other users who fly by at a high altitude will be able to see this message, and can move in closer to communicate with the group and find out more details about why they are sending out an “SOS” message.

In some embodiments, the formation is selected by the host when the invitation is sent out to other users to fly with her. The formation can be selected from various shapes, such as a wedge, circle, triangle, square, and so on, or as a set of letters, as described above. When the other users become guests, they fly towards the host, but instead of merging points of view, they fly in close proximity to the host at a place computed by a ‘best fit’ algorithm (e.g., if the host has selected a circle formation and there are only three users, they would be distributed as the nodes in an equilateral triangle). In some embodiments, the guests' places are simply marked and the guests are responsible for placing themselves at the appropriate mark. In other embodiments the guests' figurines are ‘snapped in’ to the computed places when they get close, similar to the actions of a black hole.

As is clear from the above description, this three-dimensional shared virtual representation of Planet Earth encourages people to meet and interact with each other. As a result of these interactions, often people would like to save each others' contact information so that they can find each other again at a later point in time. Typically, there are two kinds of people that a user would like to keep handily for future contact: those who were randomly encountered and who the user would like to talk to again, and those that the user already knows and would like to be able to contact whenever they are also using Google Earth.

In various embodiments there are different ways of storing these people. For the random or serendipitous encounters, the user can ask for permission from the person to store them as a place mark. The place mark will take the user straight to the other person when the other person is online, similar to how the sentinels described above work, and will appear grayed out when the other person is offline. For the people that the user already knows, the user can send invitations to join the user in this three-dimensional shared virtual space. If the user's invitation is accepted, the other person and the user will appear as place marks on each other's display screens.

The invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user. The user can provide input to the computer system through various input devices such as a keyboard and a pointing device, such as a mouse, a trackball, a microphone, a touch-sensitive display, a transducer card reader, a magnetic or paper tape reader, a tablet, a stylus, a voice or handwriting recognizer, or any other well-known input device such as, of course, other computers. The computer system can be programmed to provide a graphical user interface through which computer programs interact with users.

Finally, the processor optionally can be coupled to a computer or telecommunications network, for example, an Internet network, or an intranet network, using a network connection, through which the processor can receive information from the network, or might output information to the network in the course of performing the above-described method steps. Such information, which is often represented as a sequence of instructions to be executed using the processor, may be received from and outputted to the network, for example, in the form of a computer data signal embodied in a carrier wave. The above-described devices and materials will be familiar to those of skill in the computer hardware and software arts.

A number of implementations of the invention have been described. Nevertheless, it will be understood that various modifications may be made without departing from the spirit and scope of the invention. For example, all of the interactions described above have been described in the context of Google Earth. However, it should be clear that any continuous three-dimensional virtual space can be used as a platform for the types of interactions described above. For example, imagery showing the interior of the human body can be used and physicians may “fly” through blood vessels, and so on, similar to what was described above, and discuss treatment options for various abnormalities that are found, and so on. Text messages were described as getting smaller as the broadcasting user gets further away from the receiving user. However, other mechanisms can also be used, such as the text message having the same size but fading away or changing colors. Audio messages were described as being directional and in stereo, but they can of course also be non-directional and in mono. The broadcasting was described as being spherical, but of course any geometrical shape is possible, such as cubes, or “horizontal slices” so that only users at the same height above Earth as the broadcasting user can receive the broadcast message, and so on. In some embodiments, users may allow other users to eavesdrop on their private conversations, for example, by broadcasting their private conversations over a very small radius, and let the eavesdropping user decide whether to join the conversation or not.

The above interactions have been described by way of example in terms of exploring planet Earth, flying with other users, and so on. It should however be realized that these basic functionalities can be used to stage various types of games and contests. For example, various types of scavenger hunts can be organized in which teams of users compete against each others in finding and solving virtual clues that are hidden at various places on the representation of planet Earth, and so on. Other examples include guided tours, high-school or college reunions, political rallies, capture-the-flag and other spatial team games or quests, and so on. The various modes of interactions that have been described above can also be used in other settings than Google Earth. For example, in various mapping applications, which also provide a continuous space, but which today offer no capabilities of users to interact with each other. Accordingly, other embodiments are within the scope of the following claims.

1. A computer-implemented method comprising:
displaying, with two or more computing devices, to two or more users a respective views of a portion of virtual representations of Earth, each view being based on a set of real world coordinates that identifies a current virtual position of the user that corresponds to an actual geographical portion of the Earth represented by the virtual representation associated with such view, wherein each virtual representations includes a plurality of different displayable portions of the Earth from different points of view corresponding to different virtual positions;
displaying, with at least one of the two or more computing devices, within a current view, one or more figurines representing other users that are looking at a similar portion of the virtual representation of the Earth as that of the current view, wherein each figurine is shown in the current view at a real world coordinate position corresponding to a current virtual position of a respective other user that corresponds to an actual geographical portion of the Earth represented by the virtual representation associated with such view;
receiving, with the two or more computing devices, a request from the user to interact with one or more of the other users whose figurines are displayed within the current view;
transmitting, with the two or more computing devices, the request to the one or more other users; and
establishing, with the two or more computing devices, interactions between the requesting user and the one or more other users based on responses received from the one or more other users to the request.

2. The method of claim 1, wherein displaying figurines includes:
displaying figurines only of other users that would like to be visible to the user.

3. The method of claim 1, wherein displaying figurines includes:
displaying customized figurines of at least some other users, according to preferences selected by the other users represented by the customized figurines.

4. The method of claim 3, wherein the customized figurines include one or more of: a geometrical shape, a color, an image, and a video.

5. The method of claim 3, wherein the customized figurines include a status indicator showing the other users' availability for interactions with the user.

6. The method of claim 1, wherein receiving a request from the user to interact with one or more of the other users includes:
receiving a request to broadcast a message to all other users whose current position is within a region of influence centered on the current position of the user.

7. The method of claim 6, wherein the region of influence is a sphere of a specified radius, centered on the current position of the user.

8. The method of claim 6, wherein receiving a request to broadcast a message to all users within a region of influence further comprises:
determining whether the user has permission to broadcast a message to all other users within the region of influence; and
in response to determining that the user has permission, broadcasting the message.

9. The method of claim 1, wherein receiving a request from the user to interact with one or more of the other users includes:
receiving a request to send a private message to a single user.

10. The method of claim 1, wherein receiving a request from the user to interact with one or more of the other users includes:
receiving a request to broadcast a message to a selected group of other users independently of the current positions of the other users in the selected group of other users.

11. The method of claim 1, wherein the interactions between the requesting user and the one or more other users include one or more of:
communicating by instant text messages, communicating by audio, and communicating by video.

12. The method of claim 1, wherein receiving a request from the user to interact with one or more of the other users includes:
receiving a request to join one of the other users at a current virtual position of the other user and to look at a same portion of the virtual representation of the Earth.

13. The method of claim 12, further comprising:
joining the other user when the other user moves from the current position of the other user to a different position.

14. The method of claim 1, further comprising:
receiving a request from the user to add a place mark to the current virtual position before moving to a new virtual position, the place mark being visible to the other users and providing a means for the other users to request interaction with the user after the user has moved away from the current virtual position.

15. The method of claim 1, further comprising:
moving from the current virtual position to a new virtual position and leaving a trail visible to the other users, such that anyone of the other users can follow the path taken by the user when moving from the current virtual position to the new virtual position.

16. The method of claim 1, further comprising:
saving contact information in a list about the one or more other users with whom interactions were established, such that the one or more other users can be contacted again.

17. The method of claim 16, further comprising:
asking the one or more other users for permission to save their contact information in the list; and
saving contact information only for the one or more other users who give permission to save their contact information.

18. The method of claim 1, wherein:
the virtual representation of the Earth is generated from satellite imagery of the Earth.

19. A computer program product, stored on a non-transitory computer readable medium, comprising instructions operable to cause a computer to:
display to a user a view of a portion of a virtual representation of Earth, the current view being based on a set of real world coordinates that identifies a current virtual position of the user that corresponds to an actual geographical portion of the Earth represented by the virtual representation associated with such view, wherein the virtual representations include a plurality of different displayable portions of the Earth from different points of view corresponding to different virtual positions;
display, within the current view, one or more figurines representing other users that are looking at a similar portion of the virtual representation of the Earth as that of the current view, wherein each figurine is shown in the current view at a real world coordinate position corresponding to a current virtual position of a respective other user that corresponds to an actual geographical portion of the Earth represented by the virtual representation associated with such view;
receive a request from the user to interact with one or more of the other users whose figurines are displayed within the current view;
transmit the request to one or more computers associated with the one or more other users; and
establish interactions between the requesting user and the one or more other users based on responses received from the one or more other users to the request.

20. A computer-implemented method for interacting with one or more users in a shared virtual reality space representing Earth, the shared virtual reality space being generated from satellite imagery of planet the Earth, the method comprising:
sending a set of real world coordinates to a remote server, the set of coordinates representing a current position of a user in the shared virtual reality space;
receiving from the remote server information representing a view of a virtual representation of a geographical. portion of the Earth from the current position of the user that corresponds to an actual geographical portion of the Earth represented by the virtual representation associated with such view, wherein different geographical portions of the Earth are received for different positions of the user;
receiving from the remote server a set of figurines representing one or more other users that are simultaneously located proximate to the current position of the user in the shared virtual reality space, wherein the one or more other users are simultaneously looking at a similar portion of the view of the graphical portion of the Earth generated from satellite imagery;
displaying the received information and set of figurines to the user, wherein each figurine is shown at a real world coordinate position corresponding to each other user's current position that corresponds to an actual geographical portion of the Earth;
receiving user input requesting an interaction with one or more of the other users;
transmitting the request to the remote server; and
establishing interactions between the requesting user and the one or more other users based on response information to the request received from the server.
